(19) United States
(12) Patent Application Publication
(10) Pub. No.: US 2024/0239640 A1
(43) Pub. Date: Jul. 18, 2024

(54) LIFTING DEVICE FOR COVERS

(71) Applicant: John DOHERTY, Middle Village, NY (US)

(72) Inventor: John DOHERTY, Middle Village, NY (US)

(21) Appl. No.: 18/560,247

(22) PCT Filed: May 13, 2022
(86) PCT No.: PCT/US22/29143

§ 371 Date: Nov. 10, 2023

Related U.S. Application Data
(60) Provisional application No. 63/277,357, filed on Nov. 9, 2021.

(51) Int. Cl. B66F 19/00; B65G 7/12; E02D 29/14

(52) U.S. Cl. CPC B66F 19/005; B65G 7/12; E02D 29/1445

(57) ABSTRACT

A first embodiment of a lifting device for a frame cover comprises a pair of arms, each arm having a proximal end comprising a shank and a distal end comprising a hook configured to grasp the frame cover via a hole or other structure therein. A clamp is configured to maintain the shanks of the arms in a fixed parallel orientation during use. A second embodiment comprises a U-shaped horizontal bracket having a pair of pivot slots, and a pair of angled gripper arms pivotally connected to the U-shaped bracket at the pivot slots. Each gripper arm has a notch, hook, or other connector at a lower end thereof for facilitating grip of a frame cover. The device has a lifting point for connection to a lifting mechanism to thereby provide a lifting system for raising frame covers or other structures using the inventive lifting device.

This application claims the priority benefit of U.S. provisional patent application No. 63/188,527 filed May 14, 2021, and U.S. provisional patent application No. 63/277,357 filed Nov. 9, 2021, the contents of both of which are incorporated by reference herein in their entirety.

### FIELD OF THE INVENTION

The present invention is directed to improvements in lifting devices for raising and positioning frame covers such as manhole covers.

### BACKGROUND

There are many tasks that require more strength than a single individual may safely achieve, yet do not warrant the use of heavy machinery. For example, frame covers such as concrete slabs and manhole covers can be very hard to lift and remove from the ground. Although frame covers are usually not very large, they are typically made from materials such as concrete and steel and therefore are extremely heavy and cumbersome to lift and maneuver by a single individual. In practice, frame covers are frequently partially lifted using a single long-handled hook and the covers are then manually moved away from the frame by dragging or using a dolly. Although such methods can be effective, they are inconvenient and cumbrous, and there is a risk that the covers may drop, thereby causing personal injury to a worker or damaging the cover or an adjacent surface, or scratching or gouging the adjacent surface as the cover is dragged.

There is therefore an unmet need for a device which allows an individual to lift or reposition heavy items in a straightforward manner with minimal risk of injury.

### SUMMARY OF THE INVENTION

The present invention addresses the problems discussed above and provides a lifting device for lifting heavy objects such as (but not limited to) frame covers.

One aspect of the present invention is directed to a lifting device for a frame cover, such as a manhole cover. In an embodiment, the lifting device comprises a pair of arms, each arm having a proximal end and a distal end. The proximal end of each arm comprises a shank and the distal end of the arm comprises a hook configured to grasp or fit into a frame cover, via a hole or other retaining structure on the frame cover. The shanks are maintained in a fixed parallel orientation during use by a clamp or other fastener. The lifting device has at least one lifting point for connection to a lifting mechanism in order to raise and lower the device, and thereby raise and lower the frame cover as desired.

The arms are placed in a shank-to-shank orientation, with the proximal ends of the shafts arms parallel and alongside to each other, while the distal ends of the arms comprising the hooks are at opposite ends of the device. Each arm of the lifting device may have an identical structure, or each arm may be non-identical and have a different shape, as dependent on the particular configuration of the frame cover to be raised. The ability of a user to select a particular combination of pairs of arms allows the invention to be assembled in a modular manner.

The arms may be solid, hollow, or have apertures along their lengths, depending on the particular embodiment. The arms may have a constant cross-section or a varying cross-section as deemed suitable. Each arm may be manufactured as a single structure, or as a combination of two or more separate structures which are joined or used together. It is understood that the arms are to have sufficient strength to lift the frame cover without collapsing or buckling under its weight. In one embodiment, the arms may be manufactured as a set of several different sizes or configurations so that a user may select the most appropriate pair of arms for a particular frame cover.

The clamp may have any suitable structure to maintain the arms in an immovable configuration. This fastener is referred to as a “clamp” for ease of discussion, although any fastener which can maintain the arms in an immoveable arrangement can be used without limitation. In one embodiment of the invention, the lifting device comprises a pair or a plurality of clamps or fasteners (such as two, three, four, five, or more clamps or fasteners) which are placed along the shafts of the arms to maintain the shafts in a fixed parallel orientation during use of the device. In one particular embodiment, two clamps may be placed equidistantly over the shafts of parallel arms to maintain the arms in a fixed orientation during use. In an exemplary embodiment, the clamp is a screw clamp. The device may also comprise an additional optional locking mechanism which further locks the arms in the desired parallel position. The clamp(s) or other locking mechanism maintain the arms in a fixed relationship during use of the device and can be relaxed or otherwise loosened to permit the length of the device to be adjusted, for example, to facilitate removal of the device from the frame cover.

In other embodiments, the shanks of the arms may have a number of bores or apertures along their lengths through which a fastener such as (but not limited to) a clamp or screw (or a plurality of such fasteners) may be placed. The fastener maintains the shanks of the arms in a fixed position during use, and can be released or removed so that the shanks can be adjusted or repositioned.

The hooks of the inventive lifting device are placed into holes, loops, or other apertures or structures of a frame cover during use of the device. In order to facilitate placement into the holes of the frame cover, the hooks may have a tapered or constant cross-section. The hooks may have a round, square, triangular, or other cross-sectional shape. The hooks may have a hollow or solid configuration, as dependent upon the particular embodiment. As stated above, the length of the device may be adjusted so that the hooks fit optimally into the frame cover.

One embodiment of the lifting device comprises a U-shaped horizontal bracket comprising a pair of pivot slots, and a pair of angled gripper arms pivotally connected to the horizontal bracket at the pivot slots. Each gripper arm has a notch (or other gripping feature) at a lower end thereof for improved grip of a frame cover. The gripper arms fit into holes of the frame cover to grip the frame cover. For ease of discussion, the horizontal bracket will be described as having a U-shape even though the bracket will be typically oriented so that the bottom of the “U” is the top of the bracket, as illustrated in the Figures.

In more particular embodiments, the lifting apparatus may comprise three or more angled gripper arms, and the principles of the invention as discussed herein will be equally applicable to such further embodiments.

In one embodiment, the U-shaped horizontal bracket may have a plurality of pivot slots distributed along a length of the U-shaped bracket for adjusting the distance between the angled gripper arms. The plurality of pivot slots permits adjustment of the position of the gripper arms relative to the U-shaped horizontal bracket, and allows the distance between the gripper arms to be customized for improved handling.

Each gripper arm may comprise a strengthening gusset in the interior angled portion of the gripper arms for reinforcement and improved resistance to bending or other deformation. In one embodiment, the strengthening gusset may be molded as an integral component of the angled gripper arm to provide increased strength to prevent the angled gripper arm from collapsing or bending from the weight of a load, or the strengthening gusset may be a separate component affixed to the gripper arm.

The lifting device may also comprise at least one lifting handle on an upper surface of the U-shaped bracket. The lifting device may conveniently have a pair (or more) of lifting handles for balancing the weight load on the lifting device.

The angled gripper arms may be pivotally connected to the U-shaped bracket via pivot pins or other connectors which permit the gripper arms to pivot, swivel, or rotate about the connectors. The pivot pins may comprise a mechanism such as a clip for securing an end of the pivot pin to prevent the pivot pin from being dislodged from the lifting device. The pivoting connection of the gripper arms to the bracket permits the gripper arms to independently move freely at any angle permitted by the geometry of the lifting device.

The angled gripper arms may be solid or hollow, depending on the particular embodiment. Each angled gripper arm may be conveniently manufactured as a single structure, although in other embodiments the gripper arm may be manufactured as a combination of two or more separate structures. The angled gripper arms may be tapered in order to facilitate fitting into the holes of the frame cover. The gripper arms may have a round, square, triangular, or other cross-sectional shape.

A top surface of the U-shaped horizontal bracket can be configured so as to prevent movement of the angled gripper arms above the U-shaped bracket. That is, the top surface of the U-shaped horizontal bracket may be configured to function as a “stop” and thereby prevent the angled gripper arms from moving higher than the horizontal bracket.

The various embodiments of the inventive device has one or more lifting points for connection to a lifting mechanism which raises or lowers the device. In one embodiment, the lifting point is an eye loop which is formed as an integral part of the arm. The lifting point may be located at any position on or along the device (for example, at the midpoint; at opposite ends; or at the midpoint and opposite ends), and there may be any number of lifting points, such as one, two, three, four, five, or more. In one embodiment, the lifting point is configured as an integral part of each arm. In alternative embodiments, the lifting points are separate structures such as loops having eyes or apertures and are moveable and/or fixable along the shafts. In an exemplary embodiment, the lifting device has two lifting points wherein each lifting point is located at the distal end of each arm adjacent to the hook, or along the length of the arm of one arm or each arm. In general, it is desirable for the lifting point(s) to be positioned in complementary locations so that the device is balanced when lifting the frame cover, thereby minimizing uneven weight stresses on the inventive lifting device or the frame cover.

The lifting device may be used with frame covers such as manhole covers or other covering structures or other heavy objects as may be found useful. The frame cover can have any shape, such as round, square, or rectangular. The lifting device may be manufactured from any particular material or combination of materials such as (but not limited to) structural steel, high tensile steel, alloys such as aluminum alloys, and composites and synthetics such as fiber-reinforced plastic. It may be desirable in particular instances to apply a coating (for example, paint, electroplate, or powder coating) to the components of the lifting device to prevent oxidation or deterioration, or to label particular sizes with the same color to facilitate identification. In one embodiment, the device may have indicia such as a manufacturer's logo or device.

Another aspect of the present invention is a lifting system for lifting a frame cover comprising the inventive lifting device as discussed herein and a lifting mechanism. The lifting mechanism raises or lowers the lifting device and thereby the frame cover, and may be manually-operated or electrically-operated. Examples of lifting mechanisms include a winch, pulley, jack, or other mechanism that can raise the lifting device and frame cover. Certain embodiments of lifting systems may include a support structure such as a frame or scaffold. The lifting mechanism is attached to the device at the lifting point using a chain, rope, irons, hoop, coil, shackle, or other suitable connector. In an embodiment of this aspect, the frame cover is a manhole.

### BRIEF DESCRIPTION OF THE DRAWINGS

The foregoing and other objects and advantages will be apparent upon consideration of the following detailed description, taken in conjunction with the accompanying drawings, in which:

FIG. 1 is a front view of a first exemplary embodiment of a lifting device according to a first aspect of the invention.

FIG. 2 is a front view of a second exemplary embodiment of a lifting device according to the first aspect of the invention.

FIG. 3 is a top view of the embodiment of FIG. 1.

FIG. 4 is a top view of the embodiment of FIG. 2.

FIG. 5 is a front perspective view of an exemplary embodiment of a lifting device according to a second aspect of the invention.

FIG. 6 is a rear perspective view of the embodiment of FIG. 1.

FIG. 7 is a front plan view of the embodiment thereof.

FIG. 8 is a rear plan view of the embodiment thereof.

FIG. 9 is an elevated front perspective view showing the interior of the embodiment thereof.

FIG. 10 is an elevated rear perspective view of the embodiment thereof.

FIG. 11 is a left side view of the embodiment thereof.

### DETAILED DESCRIPTION OF THE INVENTION

The invention will now be described with reference to the Figures, wherein like reference numerals refer to like elements.

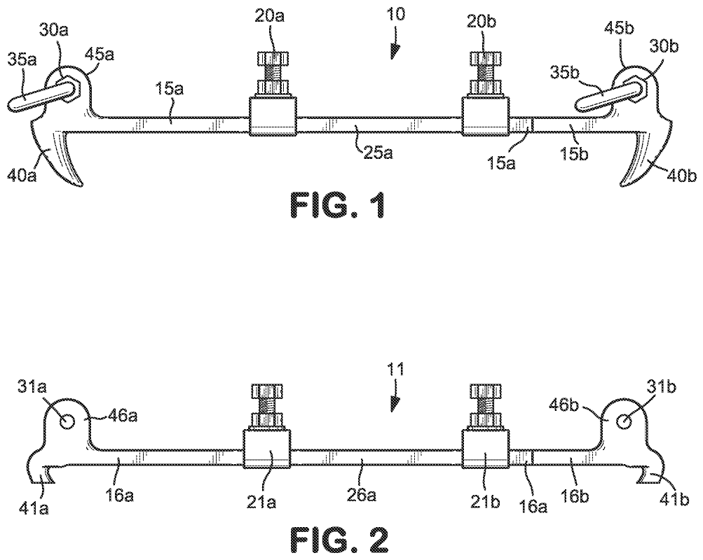

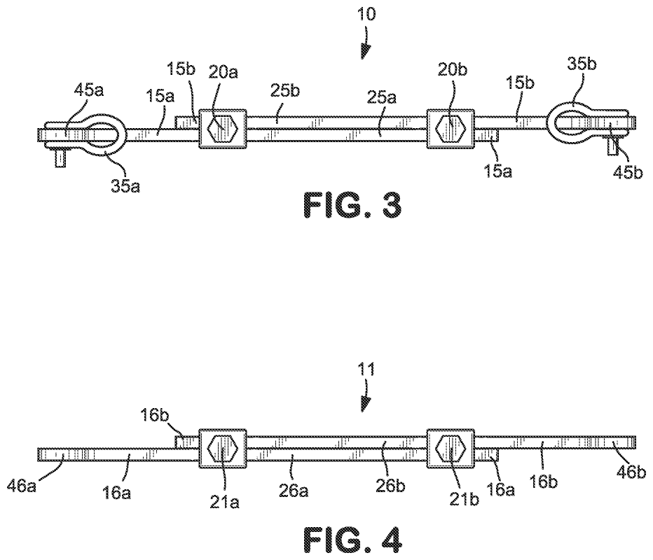

FIGS. 1 and 3 provide front and top views, respectively, of a first embodiment of a lifting device 10 according to the invention. FIGS. 2 and 4 provide front and top views, respectively, of a second embodiment of a lifting device 11 according to the invention. As the features of the two exemplary embodiments 10, 11 are generally comparable, the two embodiments will be discussed together.

Lifting device 10, 11 comprises a pair of arms 15a/15b or 16a/16b. Each arm 15a/15b, 16a/16b has a proximal end comprising a shank 25a/25b, 26a/26b, and a distal end comprising a hook 40a/40b, 41a/41b configured to grasp the frame cover by fitting into a hole therein (not shown). In FIGS. 1-4, a pair of clamps 20a/20b, 21a/21b are configured to maintain the shanks 25a/25b, 26a/26b of the arms 15a/15b, 16a/16b in a fixed parallel orientation during use.

A lifting point 45a/45b, 46a/46b for connection to a lifting mechanism is present at the distal end of each arm 15a/15b, 16a/16b as an integral component. In other embodiments, a lifting point can be a separate component affixed or applied to the arms. In FIGS. 1 and 2, the lifting points 45a/45b, 46a/46b comprise an eye loop 30a/30b, 31a/31b. For illustration purposes, lifting device 10 is shown in FIG. 1 with a shackle arrangement 35a/35b (in addition to an eye loop 30a/30b) for connection to a lifting mechanism, while lifting device 11 in FIG. 2 has eye loops 31a/31b and no shackle. A rope, chain, or other connector may be passed through the eye loop 30a/30b of lifting device 11 or through the shackle 35a/35b of lifting device 10, as dependent upon the particular embodiment. In other embodiments (not illustrated), a rope or chain having an end connector such as a hook, spring action clip, or locking claps.

Use of the lifting device as part of a lifting system will now be described. The lifting device 10, 11 may be connected to a lifting mechanism (not illustrated) as a preliminary step, or the lifting device 10, 11 may be connected to the lifting mechanism after the device has been affixed to a cover frame. Connection of the lifting device 11, 12 to the lifting mechanism generally involves connecting the lifting points 45a/45b, 46a/46b of the lifting device 11, 12 to a winch, pulley, or other lifting mechanism using a connector such as a chain, rope, or tie. The lifting mechanism may be a stand-alone device or it may be mounted to a moveable structure such as a vehicle or a wheeled jack. As frame covers are typically heavy, it is understood that the connectors (chain, rope, tie, etc.) will need to be sufficiently strong to support the weight of the frame cover and lifting device. The connection to the lifting points 45a/45b, 46a/46b may be through an opening such as an eye or eye loop 30a/30b (as exemplified for device 11), or through an shackle 35a/35b or other connector attached to the device (as exemplified for device 10).

To raise the frame cover, the lifting device 10, 11 is positioned over the frame cover (such as a manhole cover), and the hooks 40a/40b, 41a/41b are then inserted into corresponding holes (or other retaining structure) of the frame cover. The hooks 40a/40b, 41a/41b are generally located symmetrically on the lifting device so that the frame cover is balanced and not off-center when the lifting device 10, 11 is raised. The hooks 40a/40b, 41a/41b may be inwardly-pointing to the interior of the device as illustrated in FIGS. 2-4, or the hooks 40a/40b, 41a/41b may be outwardly-pointing (not illustrated). Combinations of inwardly and outwardly-pointing hooks are also within the scope of the invention. The clamps 20a/20b, 21a/21b can be loosened or opened to allow the overlapping lengths of the shanks 25a/25b, 26a/26b of the arms 15a/15b, 16a/16b to be adjusted horizontally as may be necessary to shorten or lengthen the distance between the hooks 40a/40b, 41a/41b to thereby optimize the fit of the hooks into the holes of the frame cover. In other embodiments, the hooks 40a/40b, 41a/41b may have a fishhook shape and are fitted into shackles, loops, or similar structures which are part of a frame cover.

After the hooks 40a/40b, 41a/41b are inserted in the holes (or other grasping or retaining structure) of the frame cover, the lifting mechanism is attached to the lifting device 10, 11 (if not connected already) and the lifting device 10, 11 is lifted via the lifting mechanism. The frame cover can then be fully lifted off the frame using the lifting mechanism so that a worker can attend to the project at hand. In particular embodiments, the lifting mechanism may raise the frame cover and move it away from the frame.

To place the cover back on top of the frame, the steps described are reversed. The lifting mechanism is lowered to move the lifting device 10, 11 in a downward direction so that the frame cover is repositioned back onto the frame. The arms 15a/15b, 16a/16b are adjusted to remove them from the frame cover, for example, by loosening the clamps 20a/20b, 21a/21b. The lifting device 10, 11 is then removed entirely from the cover and is subsequently available for lifting another frame cover using the steps described above. The lifting mechanism may remain attached to the lifting device, or the lifting device may be removed from the lifting mechanism, as dependent upon the particular implementation of the invention.

In alternative embodiments of the invention, the hooks 40a/40b, 41a/41b may be provided with notches, loops, or additional gripping structures which can connect to loops, hooks, or other structures which are part of the frame cover, rather than into holes located in the frame cover. In such embodiments, the inventive lifting device can be used to lift frame covers which do not have holes but have other structures which can be used for lifting purposes. In particular embodiments, each arm 15a/15b, 16a/16b of the lifting device 10, 11 may comprise two or more hooks. Such embodiments permit a single arm to be used with different frame cover configurations.

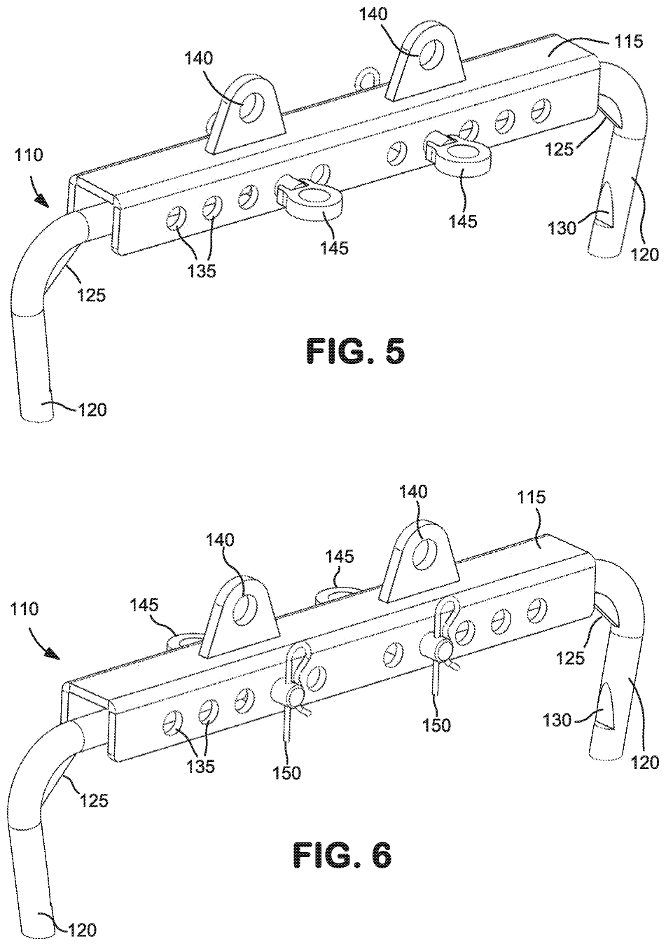

FIGS. 5 and 6 provide front and rear perspective views, respectively, of an exemplary embodiment of a lifting device 110 according to a second aspect of the invention. In accordance with this exemplary embodiment, the lifting device 110 comprises a U-shaped horizontal bracket 115 to which two angled gripper arms 120 are pivotally connected. The U-shaped horizontal bracket 115 is oriented so that the bottom of the “U” forms the top of the horizontal bracket 115. The horizontal bracket 115 has a plurality of pivot slots 135 to which the angled gripper arms 20 are pivotally connected. The gripper arms 120 are angled so as to grasp a frame cover such as a manhole cover. The interior angle of the gripper arms 120 will depend upon the particular embodiment and may range, for example, between about 30° and about 70°, while in other embodiments, the angle may be outside of this range. In certain embodiments, the angled gripper arm 120 may resemble a boomerang.

The U-shaped horizontal bracket 115 has a pair of lifting handles 140 on its upper surface. The lifting handles 140 are affixed to a winch or other lifting device (not illustrated) which raises and lowers the lifting device 110 during use. In other embodiments, there may be more or fewer than a pair of lifting handles 140 affixed to the horizontal bracket 115.

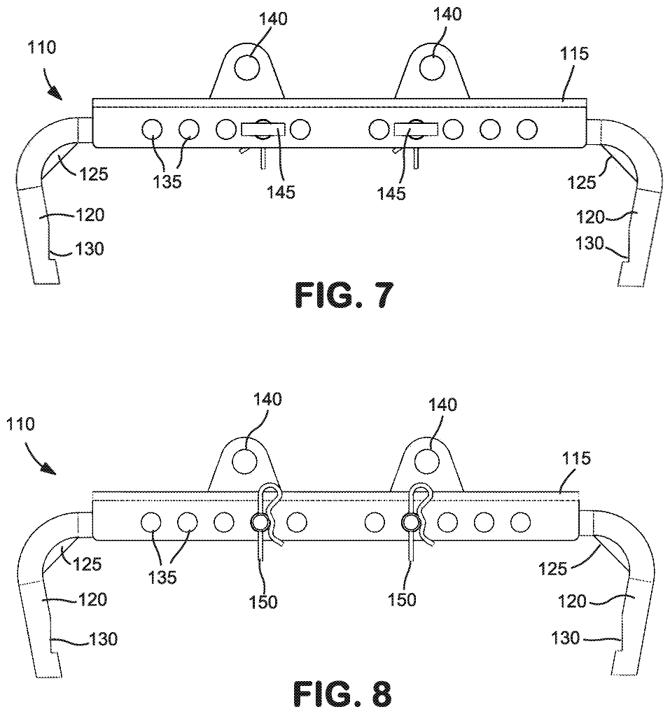

FIGS. 7 and 8 are front and rear plan views, respectively, of the embodiment of the lifting device shown in FIGS. 5 and 6. The angled gripper arms 120 are located at opposite ends of the U-shaped horizontal bracket 115. The gripper arms 120 are affixed to the U-shaped horizontal bracket 115 at a pivot slot 135. Each gripper arm 120 has a strengthening gusset 125 at the bend of the gripper arm to buttress the gripper arm so that it may withstand weight exerted on the lifting device during use. The gripper arms 120 have a notch 130 on the lower portion of their interior-facing side in order to latch onto (or into) a frame cover. The base of the notch 130 may be horizontal or angled up so as to grasp onto the frame cover. In other embodiments, the strengthening gusset is an optional feature and omitted.

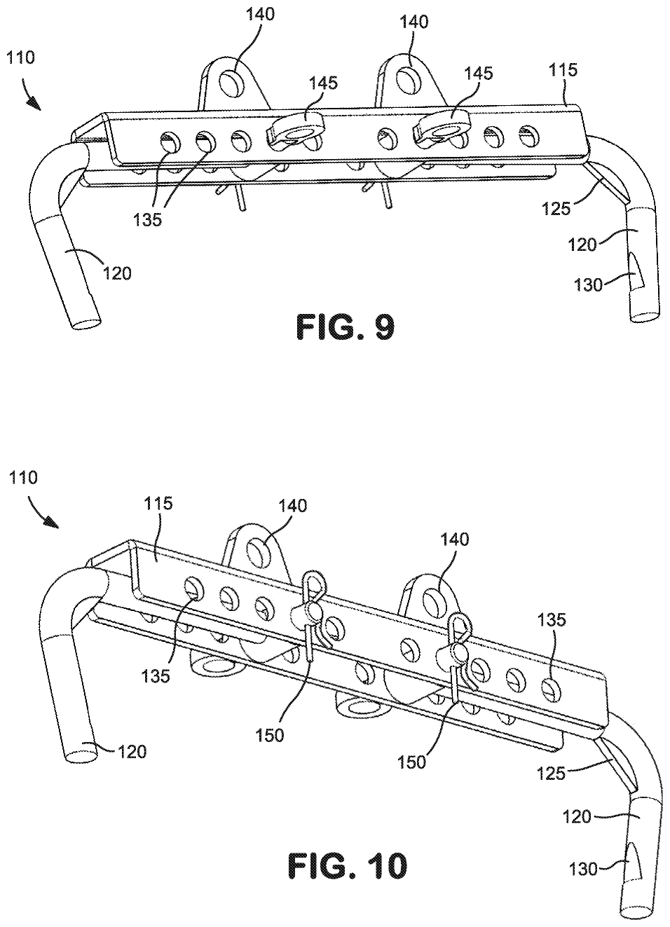

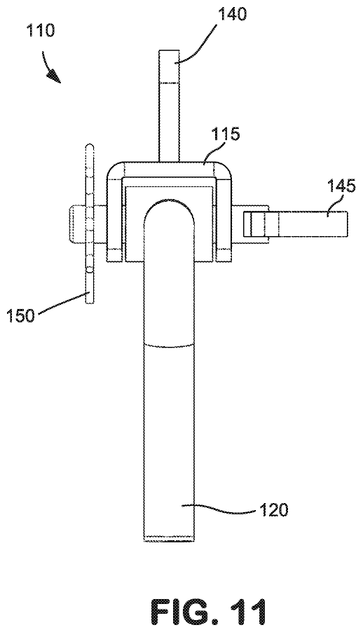

FIGS. 9 and 10 are front and rear elevated perspective views, respectively, of the embodiment of the lifting apparatus 110 shown in FIGS. 5-8. FIGS. 9 and 10 provide a view of the internal connection of the angled gripper arms 120 to the horizontal bracket 115. In the illustrated embodiment, the gripper arms 120 are connected to the horizontal bracket 115 via pivot pins 145. The gripper arms 125 may have at one end a bore configured for accepting a pivot pin 145 for coupling to the U-shaped bracket 115. The pivot pins 145 pass through a pivot slot 135 of the horizontal bracket 115 to pivotally couple the gripper arms 120 to the horizontal bracket 115. To prevent the pivot pins 145 from slipping out of the pivot slots 135, the rear side of the pivot pins may have a locking mechanism such as (but not limited to) a spring clip 150 (similar in appearance to an R-shaped cotter pin) which maintains the pivot pin in the desired position. In alternative embodiments, the pivot pins may only pass through a single pivot slot 135.

In the illustrated embodiment of FIGS. 9 and 10, there are ten pivot slots 135 arranged in two sets of five, on opposite sides of the horizontal bracket 115. The pivot slots 135 are arranged in a paired manner on both sides of the U-shaped horizontal bracket 115 so that a pivot pin 145 can pass through paired pivot slots 135. In the illustrated embodiment, the pivot pins 145 have a pivoting ring on their front side, and in particular embodiments, this pivoting ring can be flipped so that it is at a 90° angle to the axis of the pivot pin 145, to lock the pivoting pin so that it does not slip out of the pivot slot 135. The pivot slots 135 will typically be round so that a pivot pin 145 can rotate in the slot, but the pivot slots may have any convenient shape. Similarly, pivot pins 145 can have any size or dimension as long as they have sufficient structural strength to maintain the gripper arms 120 in a pivoting connection to the U-shaped horizontal bracket 115. The pivot pins 145 can be connected in a removable fashion to the horizontal bracket 115 (as illustrated in the figures) to allow gripper arms 120 to be replaced, for example, if gripper arms having a different size, shape, or configuration would be more suitable for a particular task. In other embodiments, the gripper arms 120 may be permanently joined to the horizontal bracket 115.

FIG. 11 is a left side view of the embodiment thereof. In FIG. 11, the angled gripper arm 120 has a constant diameter. In other embodiments (not illustrated), the angled gripper arm 120 may have a tapered diameter which tapers from a wider diameter near the connection by the pivot pin 145, to a narrower diameter at the opposite end near the notch 130. A tapered diameter permits the use of a single-sized gripper arm with various sized frame covers such as manhole covers.

Use of the described lifting device will generally involve connecting the lifting handles 140 of the lifting device 110 to a winch or other lifting mechanism (not shown) using chains, rope, tie, or other fasteners, if this has already not been done. The winch may be a stand-alone device or mounted to a moveable structure such as a vehicle. The lifting device 110 is positioned over a frame cover (such as a manhole cover) and the ends of the angled gripper arms 120 having the notch 130 are then inserted into holes of the frame cover. It is usually desirable to place the gripper arms 120 in the holes of the frame cover so that they are positioned symmetrically so that the frame cover is balanced and not tilted when the lifting device 110 is raised. The pivoting connection of the angled gripper arms 120 to the horizontal bracket allows the position of the gripper arms to be adjusted so they fit into the holes of the frame cover. In other embodiments, the gripper arms 120 may hook into loops or other structures of a frame cover.

After the gripper arms 120 are inserted in the holes of the frame cover, the lifting device 110 is lifted via the winch and the gripper arms 120 press against the frame cover. The upside-down U-shape of the horizontal bracket prevents the gripper arms 120 from moving higher beyond the horizontal, thereby providing a maximum horizontal position for the gripper arms and restricting their further movement. The frame cover can then be fully lifted off the frame using the winch so that a worker can attend to the project at hand.

To place the cover back on top of the frame, the steps described are reversed. The lifting device 110 is lowered via the winch so that the frame cover is back onto the frame, and the gripper arms 120 of the horizontal bracket 115 are manually adjusted to remove them from the frame cover. The lifting device 110 is then removed entirely from the cover. The lifting device 110 is subsequently available for lifting another frame cover.

In alternative embodiments of the invention, the gripper arms may be provided with deep notches, hooks, or similar grips which hook into loops affixed to the frame cover, rather than into holes located in the frame cover. In such embodiments, the inventive lifting device can be used to lift frame covers which do not have holes but have other structures which can be used for lifting purposes.

In an exemplary embodiment of the lifting device 110, the U-shaped horizontal bracket 115 has a length of about 16 inches (about 40 cm). In this embodiment, the gripper arms 120 comprise two angled sections, one of the sections having a length of about 9 inches (about 23 cm) and the second section having a length of about 6 inches (about 15 cm). In this exemplary embodiment, the angle between the two sections of the gripper arms is about 70°, and the gripper arms have a diameter of about ⅝ inches (about 16 mm). The lifting device according to this embodiment is made of structural steel.

Another aspect of the invention is directed to a system for lifting a frame cover such as a manhole cover. The system comprises the lifting device as discussed herein and a lifting mechanism which can raise or lower the lifting device. The lifting mechanism may be motorized and powered by electricity, hydraulics, or other principles, or it may be manually-operated.

In accordance with an embodiment of the invention, the inventive lifting device may be used in conjunction with a standalone multipurpose lifting device such as that described in US 2016/0368748 to Doherty, which is incorporated herein by reference in its entirety.

Examples of changes, substitutions, and alterations are ascertainable by one skilled in the art and could be made without departing from the scope of the invention disclosed herein. All references cited herein are incorporated by reference in their entirety and made part of this application.

The various embodiments described above can be combined to provide further embodiments. Aspects of the embodiments can be modified to provide yet further embodiments. The disclosed features may be implemented, in any combination and sub-combination (including multiple dependent combinations and sub-combinations), with one or more other features described herein, even if not expressly recited or described. The various features described or illustrated above, including any components thereof, may be combined or integrated in other systems. In addition, the embodiments described in the dependent claims can be combined with other independent claims to provide still further embodiments, even if not expressly recited or described. Moreover, certain features may be omitted or not implemented. Any individual features of the invention discussed herein may also be combined with other features, without limitation, even if not expressly described.

Other objects, advantages and embodiments of the various aspects of the present invention will be apparent to those who are skilled in the field of the invention and are within the scope of the description and the accompanying figures. For example, but without limitation, structural or functional elements might be rearranged, or method steps reordered, consistent with the present invention. Similarly, an element may comprise a single instance of an element or comprise a plurality of elements, such plurality functioning as a single unitary component. The structure of the invention described in various embodiments is not meant to limit the invention to those embodiments or aspects of the present invention, and other components that may accomplish similar tasks may be implemented as well. Similarly, principles according to the present invention, and methods and systems that embody them, could be applied to other examples, which, even if not specifically described here in detail, would nevertheless be within the scope of the present invention.

What is claimed is:

1. A lifting device for a frame cover, the lifting device comprising:
a pair of arms, each arm having a proximal end comprising a shank and a distal end comprising a hook configured to grasp the frame cover;
a clamp configured to maintain the shanks of the arms in a fixed parallel orientation during use; and
a lifting point for connection to a lifting mechanism for raising and lowering the lifting device.

2. The lifting device according to claim 1, wherein each arm is identical.

3. The lifting device according to claim 1, wherein each arm is non-identical.

4. The lifting device according to claim 1, wherein each arm is a single structural element.

5. The lifting device according to claim 1, wherein the device comprises a pair of clamps.

6. The lifting device according to claim 1, wherein the clamp is a screw clamp.

7. The lifting device according to claim 1, wherein the lifting device comprises a pair of lifting points, and each lifting point is located at the distal end of each arm adjacent to the hook.

8. The lifting device according to claim 1, wherein the lifting point is an eye loop.

9. The lifting device according to claim 1, wherein the shanks of the arms are horizontally slideable for adjustment of the distance between the hooks.

10. The lifting device according to claim 1, wherein the shanks of the arms are adjacent to each other.

11. The lifting device according to claim 1, wherein the frame cover is a manhole cover.

12. A lifting system for lifting a frame cover, the system comprising the lifting device according to claim 1 and a lifting mechanism.

13. The lifting system according to claim 12, wherein the frame cover is a manhole cover.

14. A lifting device for frame covers, the lifting device comprising:
a U-shaped horizontal bracket comprising a pair of pivot slots;
a pair of angled gripper arms pivotally connected to the U-shaped bracket at the pivot slots, each gripper arm having a notch at a lower end thereof for improved grip of a frame cover.

15. The lifting device according to claim 14, wherein the U-shaped bracket comprises a plurality of pivot slots distributed along a length of the U-shaped bracket for adjusting the distance between the angled gripper arms.

16. The lifting device according to claim 14, wherein each gripper arm has a strengthening gusset in an interior of the angled gripper arms for reinforcement of the angled gripper arm.

17. The lifting device according to claim 14, wherein the angled gripper arms are pivotally connected to the U-shaped bracket via pivot pins.

18. The lifting device according to claim 17, wherein the pivot pins comprise a clip for securing an end of the pivot pin.

19. The lifting device according to claim 14, wherein the angled gripper arms are solid.

20. The lifting device according to claim 14, wherein the angled gripper arms are hollow.

21. The lifting device according to claim 14, wherein the angled gripper arms are tapered.

22. The lifting device according to claim 14, wherein a top surface of the U-shaped bracket prevents movement of the angled gripper arms above the U-shaped bracket.

23. The lifting device according to claim 14, further comprising at least one lifting handle on an upper surface of the U-shaped bracket.

24. The lifting device according to claim 14, wherein the frame cover is a manhole cover.

25. A system for lifting a frame cover, the system comprising the lifting device according to claim 14 and a winch.

26. The system according to claim 25, wherein the frame cover is a manhole.
